(19) United States
(12) Patent Application Publication
(10) Pub. No.: US 2018/0057407 A1
(43) Pub. Date: Mar. 1, 2018

(54) POROUS CERAMIC STRUCTURE

(71) Applicant: NGK INSULATORS, LTD., Nagoya-City (JP)

(72) Inventor: Yunie IZUMI, Nagoya-City (JP)

(73) Assignee: NGK INSULATORS, LTD., Nagoya-City (JP)

(21) Appl. No.: 15/639,105

(22) Filed: Jun. 30, 2017

(30) Foreign Application Priority Data
Aug. 25, 2016 (JP) 2016-165007

(51) Int. Cl. C04B 35/01; C04B 35/195; C04B 35/565; C04B 38/00

(52) U.S. Cl. CPC C04B 35/01; C04B 35/195; C04B 35/565; C04B 38/0009; C04B 2235/327; C04B 2235/3213; C04B 2235/3217; C04B 2235/3262; C04B 38/0012

(57) ABSTRACT

A honeycomb structure that is the porous ceramic structure is made of a ceramic material and has pores in a structure interior, the honeycomb structure has cerium dioxide, at least a part of the cerium dioxide is incorporated in the structure interior, at least a part of the incorporated cerium dioxide is exposed on pore surfaces of the pores, and at least a part of the exposed cerium dioxide is constituted as an oxide-containing cerium dioxide including iron oxide on the surface and/or in the part.

“The present application is an application based on JP-2016-165007 filed on Aug. 25, 2016 with Japan Patent Office, the entire contents of which are incorporated herein by reference.”

### BACKGROUND OF THE INVENTION

### Field of the Invention

The present invention relates to a porous ceramic structure, and more particularly, it relates to a porous ceramic structure which is usable in various use applications including a car exhaust gas purifying catalyst carrier.

### Description of the Related Art

Heretofore, porous ceramic structures have been used in broad use applications such as a car exhaust gas purifying catalyst carrier, a diesel particulate removing filter, and a heat reservoir for a burning device. In particular, there is often used a porous ceramic structure in the form of a honeycomb (hereinafter referred to as “the honeycomb structure”) having partition walls defining a plurality of cells which extend from one end face to the other end face and become through channels for a fluid. This honeycomb structure is manufactured through an extrusion step of extruding, by use of an extruder, a forming raw material obtained by preparing and kneading a plurality of ceramic raw materials, a drying step of drying an extruded honeycomb formed body, and then a firing step of firing the honeycomb dried body on predetermined firing conditions.

As a ceramic material constituting the porous ceramic structure, there is used, for example, silicon carbide, a silicon-silicon carbide based composite material, cordierite, mullite, alumina, spinel, a silicon carbide-cordierite based composite material, lithium aluminum silicate, aluminum titanate, or the like.

When a specific surface area of partition wall surfaces or the like of the honeycomb structure is small, a sufficient amount of catalyst cannot be loaded, and a high catalytic activity might not be exerted by the honeycomb structure as it is. Consequently, for the purpose of increasing the specific surface area, a coating treatment of the honeycomb structure is performed with γ-alumina. Consequently, the specific surface area can increase, and the sufficient amount of catalyst to exert the high catalytic activity can be loaded onto the honeycomb structure (e.g., see Patent Document 1).

On the other hand, in recent years, various regulations on exhaust gases emitted from a diesel engine and the like have strictly been strengthened. Therefore, a porous ceramic structure such as the honeycomb structure for use as the car exhaust gas purifying catalyst carrier is required to have a high performance. For example, a thickness of partition walls of the honeycomb structure is decreased to decrease a heat capacity of the whole honeycomb structure, and a temperature of the honeycomb structure is immediately raised to a temperature at which the honeycomb structure exerts the high catalytic activity of the catalyst, or the partition walls are structurally adjusted to obtain a high porosity. When the porosity of the honeycomb structure decreases, there is the problem that pressure loss increases to deteriorate a fuel efficiency of the engine or the like (see Patent Document 2).

Such a coating treatment of the honeycomb structure with γ-alumina as described above has the fear that the porous partition walls are closed to decrease the porosity. To eliminate this problem, there has been investigated a method of loading the sufficient amount of catalyst without requiring the coating treatment with γ-alumina. For example, there is known a method of performing an acid treatment of the honeycomb structure made of cordierite, performing a heat treatment at 600° C. to 1000° C., and then loading a catalyst component (see Patent Document 3). This method can increase the specific surface area and can obviate the need for a step of performing the coating treatment with y-alumina (so-called “wash-coating”).

[Patent Document 1 ] JP 4046925

[Patent Document 2] WO 2013/047908

[Patent Document 3] JP-B-H05-40338

### SUMMARY OF THE INVENTION

As described above, in a method of performing a coating treatment with γ-alumina, pores of a honeycomb structure (a porous ceramic structure) are closed to decrease a porosity. Therefore, the method has the problem that pressure loss increases.

On the other hand, in a method of performing an acid treatment and a heat treatment to the porous ceramic structure as described in Patent Document 3, the coating treatment with γ-alumina is not required, and hence it is possible to achieve weight savings of the porous ceramic structure and improvement of a thermal shock resistance. However, there is the possibility that crystal lattices break themselves and there is the fear that the strength of the porous ceramic structure deteriorates. Consequently, there is desired development of a porous ceramic structure onto which a sufficient amount of catalyst to maintain a high catalytic activity is loadable without performing a coating treatment with γ-alumina and without causing a strength decrease. This also applies not only to a porous ceramic structure in which a ceramic material such as cordierite is used but also to a porous ceramic structure in which a ceramic material such as silicon carbide or a silicon-silicon carbide based composite material is used.

Thus, the present invention has been developed in view of the above circumstances and an object thereof is to provide a porous ceramic structure onto which a sufficient amount of catalyst to maintain a catalytic activity is loadable.

According to the present invention, there is provided a porous ceramic structure which achieves the above object.

[1] A porous ceramic structure which is made of a ceramic material and has pores in a structure interior, the porous ceramic structure having cerium dioxide, wherein at least a part of the cerium dioxide is incorporated in the structure interior, at least a part of the incorporated cerium dioxide is exposed on pore surfaces of the pores, and at least a part of the exposed cerium dioxide includes iron oxide on the surface and/or in the part.

[2] The porous ceramic structure according to the above [1], wherein the iron oxide forms a solid solution with the cerium dioxide.

[3] The porous ceramic structure according to the above [1] or [2], wherein an average particle diameter of the cerium dioxide is in a range of 0.1 μm to 1.0 μm.

[4] The porous ceramic structure according to any one of the above [1] to [3], wherein a ratio of the cerium dioxide in the ceramic material is in a range of 0.1 mass % to 5.0 mass %.

[5] The porous ceramic structure according to any one of the above [1] to [4], wherein a ratio of the iron oxide in the ceramic material is in a range of 0.02 mass % to 0.6 mass %.

[6] The porous ceramic structure according to any one of the above [1] to [5], wherein the cerium dioxide further includes, together with the iron oxide, a metal oxide of at least one selected from the group consisting of manganese, strontium, and aluminum.

[7] The porous ceramic structure according to any one of the above [1] to [6], wherein the ceramic material includes one of cordierite and silicon-silicon carbide as a main component.

[8] The porous ceramic structure according to any one of the above [1] to [7], which is a honeycomb structure.

According to a porous ceramic structure of the present invention, at least a part of cerium dioxide including iron oxide on the surface or the like is exposed on pore surfaces, so that a sufficient amount of catalyst to maintain a catalytic activity is loadable without performing a coating treatment, and can exert a high catalytic activity. In addition, a noble metal based catalyst does not have to be used, and hence it is expected that the cost required for the catalyst can noticeably decrease.

### BRIEF DESCRIPTION OF THE DRAWINGS

FIG. 1 is a perspective view showing one example of a constitution of a honeycomb structure;

FIG. 2A is an explanatory view schematically showing a constitution of an oxide-containing cerium dioxide (an oxide solid-solution cerium dioxide);

FIG. 2B is an explanatory view schematically showing a constitution of an oxide-containing cerium dioxide (an oxide-adhered cerium dioxide);

FIG. 3 is an enlarged schematic cross-sectional view schematically showing the oxide-containing cerium dioxide exposed on pore surfaces;

FIG. 4 shows an electron microscope image showing one example of a cross section of a porous ceramic structure;

FIG. 5 is a distribution diagram showing a distribution of cerium elements in the electron microscope image of FIG. 4; and

FIG. 6 is a distribution diagram showing a distribution of iron elements in the electron microscope image of FIG. 4.

### DESCRIPTION OF THE PREFERRED EMBODIMENTS

Hereinafter, embodiments of a porous ceramic structure of the present invention will be described in detail with reference to the drawings. It is to be noted that the porous ceramic structure of the present invention is not restricted to the following embodiments, and various design changes, modifications, improvements and the like are addable without departing from the scope of the present invention.

As shown in FIGS. 1 to 3, a porous ceramic structure of one embodiment of the present invention is directed to a porous ceramic honeycomb structure (hereinafter referred to simply as “a honeycomb structure 1”) possessing a substantially round pillar shape in the form of a honeycomb having latticed partition walls 4 defining a plurality of cells 3 which extend from one end face 2a to the other end face 2b and which are formed as through channels for a fluid.

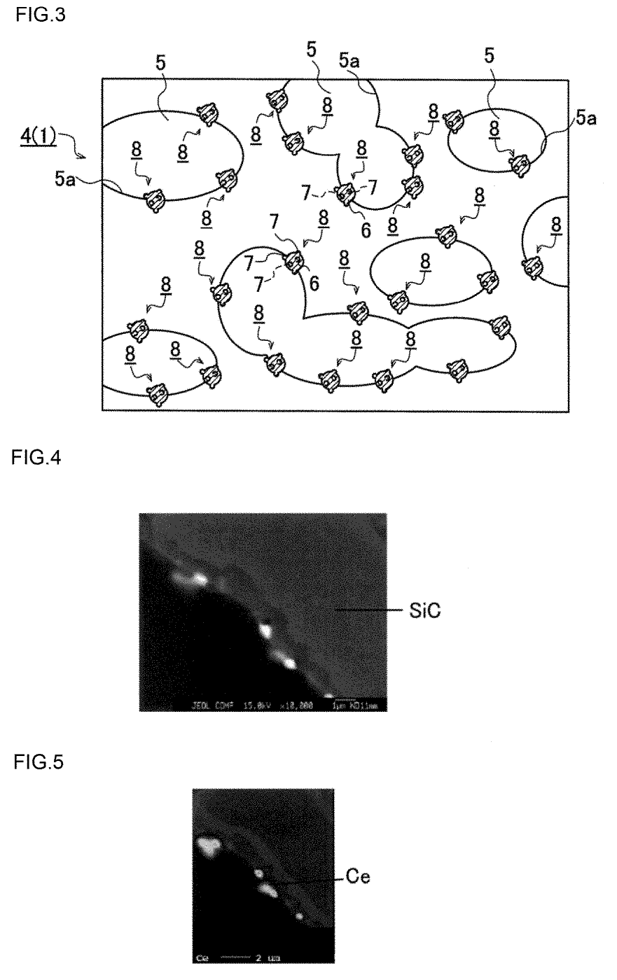

Further specifically, in the honeycomb structure 1, the partition walls 4 are made of a ceramic material, and in the partition walls 4, a plurality of pores 5 are present (e.g., see FIG. 3). Further, in a structure interior of the honeycomb structure 1, cerium dioxide 6 (CeO₂) is incorporated, and at least a part of the cerium dioxide 6 is formed to be exposed on the pore surfaces 5a of the pores 5 of the partition walls 4. Furthermore, the structure includes iron oxide 7 in a state of forming a solid solution with the cerium dioxide 6 or being adhered thereto, on the surface of the exposed cerium dioxide 6 and/or in the exposed cerium dioxide. Hereinafter, the cerium dioxide 6 including the iron oxide 7 in the state of forming the solid solution or being adhered will be referred to as “an oxide-containing cerium dioxide 8”.

Here, as the ceramic material constituting the honeycomb structure 1 (the partition walls 4), a well-known material is presumed, and an example of the material includes, as a main component, silicon carbide, a silicon-silicon carbide (Si/SiC) based composite material, cordierite, mullite, alumina, spinel, a silicon carbide-cordierite based composite material, lithium aluminum silicate, aluminum titanate or the like. It is to be noted that the porous ceramic structure of the present invention is not restricted to the honeycomb structure 1 described above, and may have any form. Furthermore, even when the structure is in the form of the honeycomb, the structure is not restricted to the substantially round pillar shape and may possess a prismatic columnar shape or the like.

An average particle diameter of the cerium dioxide 6 contained in the ceramic material constituting the honeycomb structure 1 of the present embodiment is in a range of 0.1 μm to 1.0 μm. Furthermore, a content ratio of the cerium dioxide 6 in the ceramic material is in a range of 0.1 mass % to 5.0 mass % and more preferably in a range of 0.3 mass % to 1.0 mass %. When the ratio of the cerium dioxide 6 is larger than 0.1 mass %, particles of the cerium dioxide 6 exposed on the pore surfaces 5a increase up to a sufficient amount to obtain a catalytic activity.

On the other hand, when the ratio of the cerium dioxide 6 is smaller than 5.0 mass %, an amount of the cerium dioxide 6 exposed on the pore surfaces 5a becomes suitable. Consequently, there decreases the possibility that parts of the pores 5 are closed with the exposed cerium dioxide 6, the partition walls 4 maintain a high porosity, and a defect such as increase of pressure loss does not occur. Therefore, it is especially preferable to adjust the ratio of the cerium dioxide 6 in the above directed range.

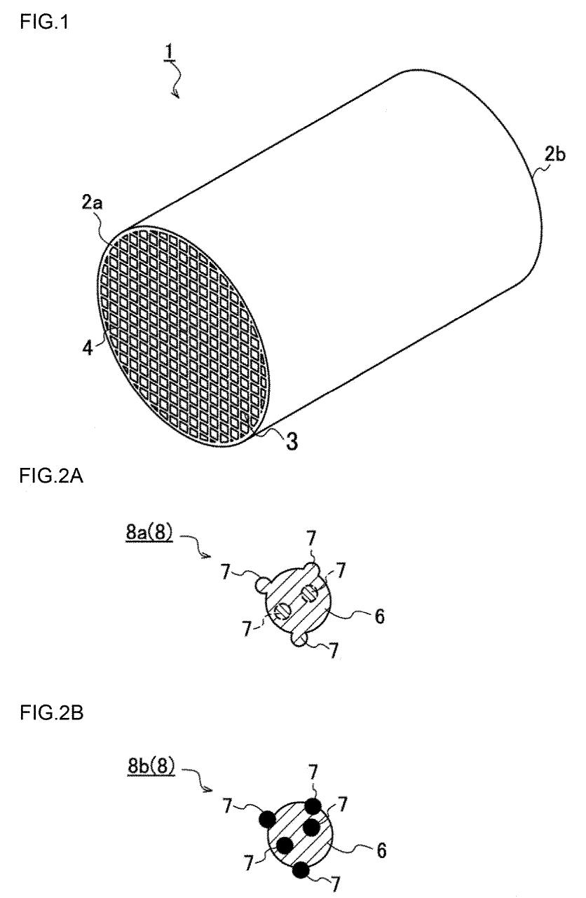

Furthermore, a ratio of the iron oxide 7 in the ceramic material is in a range of 0.02 mass % to 0.6 mass %. When the ratio of the iron oxide 7 is larger than 0.02 mass %, it is possible to sufficiently exert an effect of a catalytic performance by the oxide-containing cerium dioxide 8. On the other hand, when the ratio is smaller than 0.6 mass %, it is possible to inhibit the increase of the pressure loss. Therefore, it is especially preferable to adjust the ratio of the iron oxide 7 in the above directed range. Furthermore, there is not any special restriction on an average particle diameter of the iron oxide 7, but as schematically shown in FIG. 2, the average particle diameter of the iron oxide 7 is necessarily smaller than the above average particle diameter of the cerium dioxide 6.

As a method of providing the iron oxide 7 on the surface of the cerium dioxide 6 and/or in the cerium dioxide, for example, an impregnating method or the like is usable. Specifically, a nitrate solution of a metal oxide containing an iron component is added to powder (particles) of the cerium dioxide 6 whose average particle diameter is beforehand adjusted into the predetermined range, followed by stirring and mixing. Consequently, the cerium dioxide 6 is impregnated with the nitrate solution of the metal oxide, and this impregnated state continues for a predetermined period of time. In consequence, the nitrate solution including the iron component and the like adheres to particle surfaces of the cerium dioxide 6.

Afterward, the cerium dioxide 6 is removed from the nitrate solution and the cerium dioxide 6 is fired in the air atmosphere or the like in a state where a part of the metal oxide is adhered to the surface of the cerium dioxide. As a result, the oxide-containing cerium dioxide 8 is formed which includes the iron oxide 7 on the surface of the oxide-containing cerium dioxide and/or in the oxide-containing cerium dioxide. At this time, a content (or a content ratio) of the iron oxide 7 to the cerium dioxide 6 is suitably changeable by adjusting a concentration of the nitrate solution, a ratio of each component or the like.

Here, in the oxide-containing cerium dioxide 8, a firing temperature of a firing treatment to be performed in the air atmosphere or the like is changed, whereby the state of the iron oxide 7 to the cerium dioxide 6 is changeable into two different states. That is, it is possible to select and change to a state where the iron oxide 7 is present in the state of forming the solid solution with the cerium dioxide 6 on the surface of the cerium dioxide and/or in the cerium dioxide or a state where the iron oxide is adhered to the surface of the cerium dioxide 6 (a state of no solid solution). Here, it is known that there is a difference in a catalytic performance developing mechanism of the oxide-containing cerium dioxide 8, in accordance with the solid solution state or the adhered state of the iron oxide 7 to the cerium dioxide 6.

Further specifically, in the case of “an oxide solid-solution cerium dioxide particle 8a” (see FIG. 2A) that is the oxide-containing cerium dioxide 8 in which the iron oxide 7 forms the solid solution with the cerium dioxide 6, the cerium dioxide 6 itself has a catalyst activating function. Thus, the average particle diameter of the cerium dioxide 6 itself with which the iron oxide 7 forms the solid solution is decreased, so that it is possible to increase a specific surface area of the cerium dioxide 6 and it is possible to exert a higher catalytic performance.

On the other hand, it is known that in case of “an oxide-adhered cerium dioxide particle 8b” (see FIG. 2B) that is the oxide-containing cerium dioxide 8 in which the iron oxide 7 (mainly, Fe₂O₃) is adhered to the cerium dioxide 6, the iron oxide 7 itself has a catalyst activating function, and the cerium dioxide 6 itself does not have the catalyst activating function, but has a function of attracting oxygen molecules as a catalyst assisting operation. Thus, the average particle diameter of the iron oxide 7 itself which is adhered to the cerium dioxide 6 is decreased, so that it is possible to increase a specific surface area of the iron oxide 7 and it is possible to exert a higher catalytic performance.

In the honeycomb structure 1 of the present embodiment, at least a part of the cerium dioxide 6 is formed to be exposed on the surfaces of the plurality of pores 5 formed in the structure interior of the partition walls 4, and the iron oxide 7 is present in the state of forming the solid solution or being adhered, on the surface of the exposed cerium dioxide and/or in the exposed cerium dioxide. Consequently, it is not necessary to increase the specific surface area by a conventional coating treatment with γ-alumina (wash-coating), it is possible to increase a contact area between an exhaust gas and the oxide-containing cerium dioxide 8 that is a catalyst, and it is possible to sufficiently exert the catalytic performance by the iron oxide 7 and a performance of adsorbing nitrogen monoxide by the cerium dioxide 6 itself. As a result, a performance of a particulate removing filter for a decrease of the pressure loss or the like is not impaired.

Furthermore, in the honeycomb structure 1 of the present embodiment, the particles of the cerium dioxide 6 may further include, together with the iron oxide 7 mentioned above, a metal oxide (not shown) of at least one selected from the group consisting of manganese (Mn), strontium (Sr) and aluminum (Al).

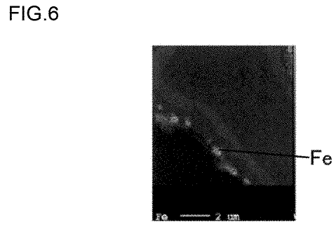

According to the honeycomb structure 1 of the present embodiment, the cerium dioxide 6 is present in an incorporated state at a predetermined ratio in the structure interior (in the ceramic material) constituting the honeycomb structure 1 (the partition walls 4), the cerium dioxide 6 is exposed on the pore surfaces 5a of the structure interior of the partition walls 4, and the iron oxide 7 forms the solid solution or is adhered (see FIG. 4 to FIG. 6).

Consequently, when the honeycomb structure 1 is used as a catalyst body for an NO₂ purifying treatment or the like, it is possible to exert the high catalytic activity by the iron oxide 7, and it is possible to achieve improvement of an NO₂ purification ratio (conversion ratio). Furthermore, the state (the solid solution state or the adhered state) of the iron oxide 7 to the cerium dioxide 6 is changed, whereby the catalytic performance developing mechanism can vary. Furthermore, the honeycomb structure includes the metal oxide of the metal other than iron, e.g., manganese, so that it is possible to exert a higher catalytic activity.

The porous ceramic structure of the present invention is not restricted to the honeycomb structure 1 mentioned above, and may be used in another configuration or mode. That is, the porous ceramic structure is usable in promoting an oxidation treatment of nitrogen monoxide and performing a purifying treatment of an NO gas included in the exhaust gas as in the honeycomb structure 1, and additionally, the porous ceramic structure is usable in promoting burning of soot trapped by a purifying treatment of the exhaust gas or adsorbing nitrogen oxides.

Hereinafter, the porous ceramic structure (the honeycomb structure) of the present invention will be described with reference to examples mentioned below, but the porous ceramic structure of the present invention is not restricted to these examples.

### EXAMPLES

Table 1 mentioned below shows ceramic materials (including inorganic raw materials and the other raw materials) constituting honeycomb structures of Examples 1 to 5 and Comparative Examples 1 to 3, blend ratios of the materials, and the like. Here, Examples 1 to 5 and Comparative Examples 1 to 3 are directed to the honeycomb structures in each of which a ceramic component (a substrate component) is constituted of a silicon/silicon carbide (Si/SiC) based composite material.

Here, in the honeycomb structures of Examples 1 to 5, cerium dioxide including iron oxide (an oxide-containing cerium dioxide) is distributed in partition walls (in a structure interior), and the honeycomb structures satisfy conditions that a ratio of cerium dioxide in the ceramic material is in a range of 0.1 mass % to 5.0 mass %, and satisfy conditions that a ratio of iron oxide in the ceramic material is in a range of 0.02 mass % to 0.6 mass %. It is to be noted that the honeycomb structure includes predetermined mass % of aluminum oxide (Al₂O₃) and strontium oxide (SrO) as aid components, in addition to the ceramic component and the oxide-containing cerium dioxide.

On the other hand, Comparative Example 1 is directed to the honeycomb structure which does not have the oxide-containing cerium dioxide and is constituted only of a substrate and another aid component, and Comparative Example 2 is directed to the honeycomb structure in which usual cerium dioxide is only distributed in pore surfaces. Furthermore, Comparative Example 3 was formed by beforehand preparing a slurried oxide-containing cerium dioxide including iron oxide and dipping the honeycomb structure in this slurry to form the oxide-containing cerium dioxide on partition wall surfaces. Hereinafter, preparation of the honeycomb structures of Examples 1 to 5 and Comparative Examples 1 to 3 will be described in detail.

1. Preparation of Honeycomb Structure

(1) Preparation of Kneaded Material

Aggregates and an oxide-containing cerium dioxide (cerium dioxide+iron oxide) of each honeycomb structure shown in Table 1 were weighed and dry-mixed for 15 minutes by use of a kneader, and water was thrown into this mixture, followed by kneading for 30 minutes further by use of the kneader, to obtain a kneaded material. At this time, an amount of cerium dioxide to be added, the necessity of the addition of cerium dioxide, a ratio of iron oxide to cerium dioxide and the like were changed, to form the respective kneaded materials for Examples 1 to 5 and Comparative Examples 1 to 3 of Table 1 described above. On the other hand, the oxide-containing cerium dioxide was beforehand prepared by impregnating iron oxide into cerium dioxide by use of an already described impregnating method or the like and further performing a firing treatment so that a part of iron oxide formed a solid solution with cerium dioxide or was adhered to cerium dioxide. It is to be noted that the preparation of the kneaded material is not restricted to the above-mentioned case of beforehand preparing the oxide-containing cerium dioxide. For example, the aggregates of the honeycomb structure may be mixed with cerium dioxide and iron oxide (or an iron nitrate solution) to form the kneaded material.

(2) Formation of Honeycomb Formed Body

Each of a plurality of types of kneaded materials prepared for each of the examples and comparative examples was formed into a pillar shape by use of a vacuum pug mill and then introduced into an extruder to extrude a honeycomb formed body in the form of a honeycomb. It is to be noted that the honeycomb formed body has a honeycomb diameter of 30 mm, a partition wall thickness of 12 mil (about 0.3 mm), a cell density of 300 cpsi (cells per square inch: 46.5 cells/cm²), and a circumferential wall thickness of about 0.6 mm, and includes therein latticed partition walls defining a plurality of cells which become through channels for a fluid.

(3) Drying and Firing of Honeycomb Formed Body

The prepared honeycomb formed body was dried with microwaves to transpire about 70% of water, and then dried with hot air at 80° C. for 12 hours. Afterward, the honeycomb formed body was thrown into a catalyst removing furnace maintained at 450° C., and degreasing was performed to remove an organic component which remained in the honeycomb formed body. Afterward, a firing temperature was set to 1450° C. and a firing treatment (main firing) was performed under argon atmosphere. Then, the specific temperature was set to 1250° C. and an oxidation treatment was performed under the atmospheric pressure. Consequently, there was formed the honeycomb structure including the oxide-containing cerium dioxide having cerium dioxide and iron oxide in the structure interior.

2. Analysis of Sample

As to each of samples of the honeycomb structures which were obtained by the above methods (Examples 1 to 5 and Comparative Examples 1 to 3), there were measured a ratio of a substrate component, ratios of cerium dioxide and iron oxide, particle diameters of cerium dioxide, specific surface areas of cerium dioxide particles, specific surface areas of iron oxide particles, and crystal phases of the respective particles. Hereinafter, specific analyzing and calculating methods will be described.

2.1 Ratios (mass %) of Respective Components of Substrate Component, Cerium Dioxide and Iron Oxide

The mass % of each component was calculated by performing analysis on the basis of ICP (inductivity coupled plasma) atomic emission spectroscopy.

2.2 Specific Surface Area and Average Particle Diameter

The specific surface area of the honeycomb structure was measured by a well-known BET method. Furthermore, the average particle diameter of cerium dioxide was obtained as a median diameter calculated by laser diffractometry. It is to be noted that except for the above laser diffractometry, the average particle diameter may be obtained by calculating particle diameters of individual particles of cerium dioxide 6 in a viewing field image observed with, e.g., a scanning electron microscope (SEM) on the basis of a size and an enlargement magnification in the viewing field image, and calculating an average value of the particle diameters as the average particle diameter. It is to be noted that the specific surface area of the honeycomb structure having the oxide-containing cerium dioxide (Examples 1 to 5) is larger than the specific surface area of the honeycomb structure which does not have the oxide-containing cerium dioxide (Comparative Example 1) (see Table 1). That is, the presence of the oxide-containing cerium dioxide becomes a factor to increase the specific surface area of the honeycomb structure.

2.3 Crystal Phase of Particles

The crystal phases of the respective particles of the prepared samples were measured by using an X-ray diffractometer (a rotating anode X-ray diffractometer RINT manufactured by Rigaku Corporation). Here, conditions of X-ray diffractometry were set to a CuKα source, 50 kV, 300 mA and 2θ=10 to 60°, and obtained X-ray diffraction data was analyzed by using commercially available X-ray data analysis software.

Table 1 mentioned below shows a summary of the measurement results obtained in the above 2.

TABLE 1

| | Ratio of substrate | | Ratios of cerium | | Other aid | | | | | | |
|---|---|---|---|---|---|---|---|---|---|---|---|
| | component/ | | dioxide and iron | | components/ | | | Ave. particle | Specific surface area of | Crystal phase of | |
| | mass % | | oxide/mass % | | mass % | | Total/ | dia. of CeO₂ | honeycomb structure | particles *² | |
| | SiC | Si | CeO₂ | Fe₂O₃ | Al₂O₃ | SrO | mass % | μm | m²/g | CeO₂ | Fe₂O₃ |
| Example 1 | 77.7 | 19.4 | 0.1 | 0.02 | 0.6 | 2.1 | 100.0 | 0.2 | 0.275 | ∘ | — |
| Example 2 | 77.6 | 19.4 | 0.3 | 0.06 | 0.6 | 2.1 | 100.0 | 0.3 | 0.281 | ∘ | — |
| Example 3 | 77.1 | 19.3 | 1.0 | 0.20 | 0.5 | 2.0 | 100.0 | 0.5 | 0.271 | ∘ | — |
| Example 4 | 76.7 | 19.2 | 1.5 | 0.30 | 0.5 | 1.8 | 100.0 | 0.7 | 0.255 | ∘ | — |
| Example 5 | 75.6 | 18.9 | 3.0 | 0.60 | 0.4 | 1.5 | 100.0 | 1.2 | 0.235 | ∘ | — |
| Comparative | 78.6 | 19.6 | 0.0 | 0.00 | 0.4 | 1.4 | 100.0 | — | 0.178 | — | — |
| Example 1 | | | | | | | | | | | |
| Comparative | 77.6 | 19.4 | 0.3 | 0.00 | 0.6 | 2.1 | 100.0 | 0.3 | 0.171 | ∘ | — |
| Example 2 | | | | | | | | | | | |
| Comparative | 79.3 | 19.8 | 0.3 | 0.03 | 0.1 | 0.4 | 100.0 | 3 | 0.222 | ∘ | ∘ |
| Example 3 *¹ | | | | | | | | | | | |

*¹ In Comparative Example 3, cerium dioxide was loaded by dipping.
*² “∘” shows the presence of the crystal phase of the particles.

3. Calculation of Amount of NO to be Adsorbed

An amount of NO to be adsorbed was calculated on the basis of a temperature-programmed desorption method which used an NO gas. Here, as a device for the calculation of the amount of NO to be adsorbed, AutoChem II (manufactured by Micromeritics Instrument Corp.) was used. Furthermore, as a gas for use in adsorption, a mixed gas of 200 ppm of NO, 10% of O₂ and He was used. The above measurement sample was disposed in a reaction tube of a heating furnace, a temperature at a time of gas adsorption was set to 250° C., and the above gas was introduced into the reaction tube. An adsorption time was set to 30 minutes. After completion of the adsorption, a He gas was introduced into the reaction tube, and on conditions that a temperature rising rate was 10° C./min, the temperature was raised from 250 to 600° C. A degassing component during temperature rise was measured with a mass spectrometer and an amount of NO to be desorbed was calculated. This amount of NO to be desorbed was obtained as the amount of NO to be adsorbed.

4. Calculation of NO₂ Conversion Ratio

Each honeycomb catalyst body prepared in the above 1 was processed into a test piece having a diameter of 25.4 mm×a length of 50.8 mm and a processed circumference was coated and treated. The obtained test piece was evaluated as a measurement sample by use of a car exhaust gas analyzer (SIGU1000 manufactured by HORIBA, Ltd.). At this time, the above measurement sample was disposed in the reaction tube of the heating furnace and the measurement sample was warmed up to 250° C. Then, a mixed gas of 200 ppm of NO (nitrogen monoxide), 10% of O₂ (oxygen) and N₂ (nitrogen) was introduced as a reactive gas into the reaction tube. At this time, an exhaust gas (an outlet gas) emitted from the measurement sample was analyzed by using an exhaust gas measurement device (MEXA-6000 FT manufactured by HORIBA, Ltd.) and respective emission concentrations (a NO concentration and an NO₂ concentration) were measured. Then, an NO₂ conversion ratio was obtained on the basis of the measurement results of the emission concentrations. Here, the NO₂ conversion ratio was calculated by (1-(NO concentration/(NO concentration+NO₂ concentration)).

5. Evaluation of NO₂ Conversion Ratio

When a value of the calculated NO₂ conversion ratio was 1.0% or more, evaluation was “A”, when the value was 0.5% or more and smaller than 1.0%, evaluation was “B”, when the value was 0.1% or more and smaller than 0.5%, evaluation was “C”, and when the value was smaller than 0.1%, evaluation was “D”. Here, when the value of the NO₂ conversion ratio is smaller than 0.1% and the evaluation is D, a measurement error by the above car gas analyzer is taken into consideration, and it is judged that NO₂ conversion is hardly done. It is considered that at least evaluation C is practically required.

Table 2 mentioned below shows a summary of the results of the evaluations of the amount of NO to be adsorbed and the NO₂ conversion ratio.

TABLE 2

| | Amount of NO to | |
|---|---|---|
| | be adsorbed | Evaluation of NO₂ |
| | μmol/g | conversion ratio |
| Example 1 | 0.10 | B |
| Example 2 | 0.28 | A |
| Example 3 | 0.10 | B |
| Example 4 | 0.08 | B |
| Example 5 | 0.05 | C |
| Comparative Example 1 | 0 | D |
| Comparative Example 2 | 0 | D |
| Comparative Example 3 | 0 | D |

6. Considerations of Evaluation Results

As shown in Table 1 and Table 2 mentioned above, it is indicated that as the average particle diameter of cerium dioxide decreases, the evaluations of the amount of NO to be adsorbed and the NO₂ conversion ratio become suitable, and it is confirmed that the average particle diameter depends on a content of cerium dioxide. In particular, the honeycomb structure of Example 2 shows the suitable result. On the other hand, it is confirmed that in case of the honeycomb structure which does not have the oxide- containing cerium dioxide as in Comparative Example 1, a value of the amount of NO to be adsorbed is 0, and the NO₂ conversion ratio has the evaluation D. Furthermore, effects are hardly recognized also in the honeycomb structure which does not contain iron oxide and only includes cerium dioxide as in Comparative Example 2. In addition, it is indicated that also in Comparative Example 4 in which the ratio of cerium dioxide is the same as in Example 2 in which the highest effect is obtainable, the evaluations of the amount of NO to be adsorbed and the NO₂ conversion ratio become lower when the catalyst is loaded by dipping.

A porous ceramic structure of the present invention is suitably utilizable as a catalyst carrier such as a car exhaust gas purifying catalyst carrier.

### DESCRIPTION OF REFERENCE NUMERALS

1: honeycomb structure (porous ceramic structure), 2a: one end face, 2b: other end face, 3: cell, 4: partition wall, 5: pore, 5a: pore surface, 6: cerium dioxide, 7: iron oxide, 8: oxide-containing cerium dioxide, 8a: oxide solid-solution cerium dioxide particle, and 8b: oxide-adhered cerium dioxide particle.

What is claimed is:

1. A porous ceramic structure which is made of a ceramic material and has pores in a structure interior,
the porous ceramic structure having cerium dioxide,
wherein at least a part of the cerium dioxide is incorporated in the structure interior, at least a part of the incorporated cerium dioxide is exposed on pore surfaces of the pores, and at least a part of the exposed cerium dioxide comprises iron oxide on the surface and/or in the part.

2. The porous ceramic structure according to claim 1,
wherein the iron oxide forms a solid solution with the cerium dioxide.

3. The porous ceramic structure according to claim 1,
wherein an average particle diameter of the cerium dioxide is in a range of 0.1 μm to 1.0 μm.

4. The porous ceramic structure according to claim 1,
wherein a ratio of the cerium dioxide in the ceramic material is in a range of 0.1 mass % to 5.0 mass %.

5. The porous ceramic structure according to claim 1,
wherein a ratio of the iron oxide in the ceramic material is in a range of 0.02 mass % to 0.6 mass %.

6. The porous ceramic structure according to claim 1,
wherein the cerium dioxide further comprises, together with the iron oxide, a metal oxide of at least one selected from the group consisting of manganese, strontium and aluminum.

7. The porous ceramic structure according to claim 1,
wherein the ceramic material includes one of cordierite and silicon-silicon carbide as a main component.

8. The porous ceramic structure according to claim 1,
which is a honeycomb structure.
